(19) United States
(12) Patent Application Publication
(10) Pub. No.: US 2011/0284141 A1
(43) Pub. Date: Nov. 24, 2011

(54) Rotating Sipe

(75) Inventors: Daniel Stephen Mathews, Lufkin, TX (US); Robert Brown, Mt. Vernon, IL (US)

(73) Assignee: Continental Tire North America, Inc.

(21) Appl. No.: 12/784,973

(22) Filed: May 21, 2010

(51) Int. Cl. B60C 11/12

(52) U.S. Cl. 152/209.18

(57) ABSTRACT

A vehicle tire includes tread blocks positioned on the tire. One or more rotating sipes are formed in each of the tread blocks. Each rotating sipe comprises first and second walls that are substantially parallel wherein the first wall includes three points that lie in an imaginary plane and a fourth point that lies outside of the imaginary plane.

### FIELD

The present disclosure relates to sipes in a vehicle tire.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicle tires are often provided with fine grooves or sipes. Sipes improve tire traction on wet surfaces.

### SUMMARY

A vehicle tire includes tread blocks positioned on the tire. One or more rotating sipes are formed in each of the tread blocks. Each rotating sipe comprises first and second walls that are substantially parallel wherein the first wall includes three points that lie in an imaginary plane and a fourth point that lies outside of the imaginary plane.

In other features the four points are located at respective corners of the rotating sipe. An angle defined by the imaginary plane, the fourth point, and one of the three points is between 5 and 30 degrees, inclusive. The tread blocks can be polygons. Each rotating sipe can include a channel having a width that is greater than a width of the rotating sipe. The channel is positioned at a periphery of the sipe. The sipes are arranged in a directional pattern.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a vehicle tire that includes rotating sipes;

FIG. 2 is a perspective view of a tire tread block that includes a rotating sipe;

FIG. 3A is a top view of a tire tread block that includes a rotating sipe;

FIG. 3B is a side view of the tire tread block of FIG. 3A; and

FIG. 3C is a front view of the tire tread block of FIG. 3A.

### DETAILED DESCRIPTION

The following description is merely exemplary in nature and is in no way intended to limit the disclosure, its application, or uses. For purposes of clarity, the same reference numbers will be used in the drawings to identify similar elements.

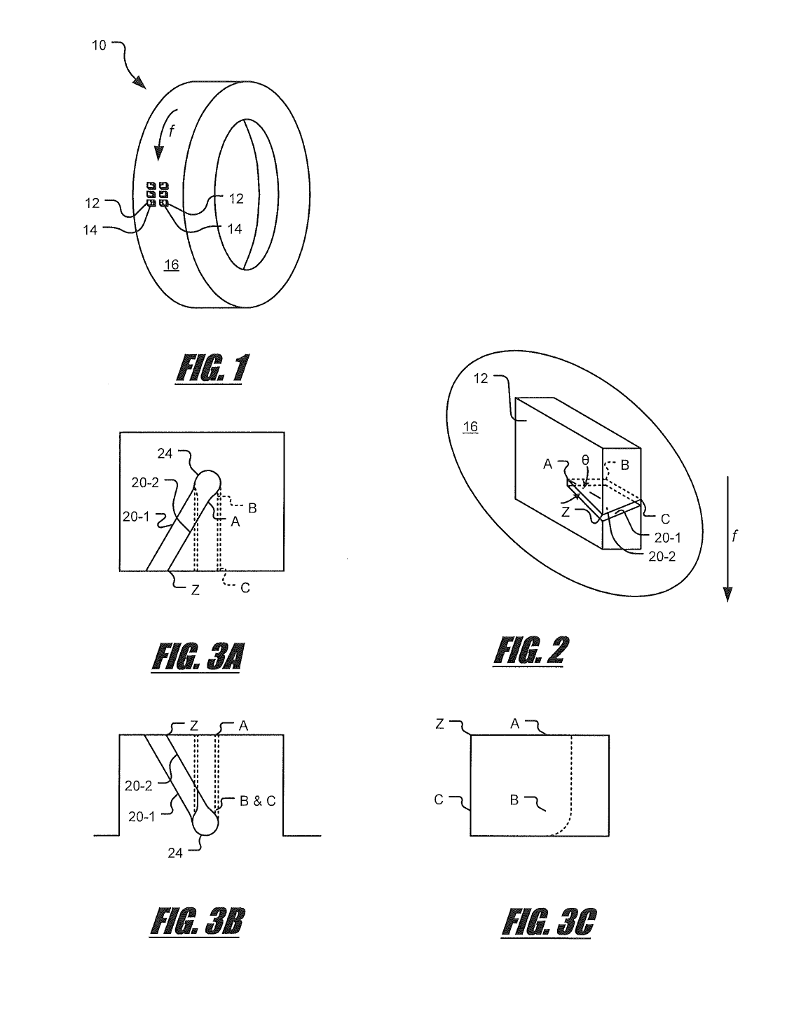

Referring now to FIG. 1, a perspective view is shown of a tire 10. Tire 10 includes a plurality of tread blocks 12. It is appreciated by those skilled in the art that in practice tread blocks 12 would be positioned around a perimeter 16 of tire 10. For the sake of clarity here only a few tread blocks 12 are depicted. An arrow f shows the direction of rotation when tire 10 is mounted on a vehicle and the vehicle is moving forward. Each tread block 12 can include one or more rotating sipes 14. Rotating sipes 14 provide tire 10 with improved wet road gripping ability while reducing sensitivity to direction of tire rotation as the tire wears. This allows the tire more reliably be rotated into different positions than directional tires of the prior art.

FIG. 2 is a perspective view of tread block 12. Those skilled in the art understand that tread block 12 can have shapes other than the simple prismatic shape that is depicted. The prismatic shape is employed here for simplicity. In some embodiments rotating sipe 14 is formed into tread block 12 when tire 10 is molded. Rotating sipe 14 may also be cut, ground, and/or thermally formed into tread block 12 after tire 10 is molded.

Rotating sipe 14 is formed by a first wall 20-1 and second wall 20-2, collectively referred to as walls 20. A void 22 is bounded by walls 20 which are substantially parallel with each other. Walls 20 are not completely planar. Instead, walls 20 have a rotating or twisted shape. The shape of walls 20 can be defined by three points A, B, and C that lie in a common imaginary plane ABC. A fourth point Z is spaced away from the imaginary plane ABC. In some embodiments an angle θ between imaginary plane ABC and a line segment AZ is between 5 and 30 degrees, inclusive.

Referring now to FIG. 3A, a top view is shown of tread block 12. In some embodiments rotating sipe 14 can be formed with a channel or passage 24. Passage 24 has a diameter that is greater than the width of sipe 14. The width of sipe 14 is equivalent to the distance between walls 20.

Referring now to FIG. 3B, a front view is shown of tread block 12. Points C and Z are in the foreground. Points A and B are in the background.

Referring now to FIG. 3C, a side view is shown of tread block 12. Sipe 14 may include a rounded or otherwise filleted shape at the corner near point B. The rounded shape can help reduce stress risers and thereby reduce the risk of a crack forming in tire 10 due to rotating sipe 14.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A vehicle tire, comprising:
tread blocks positioned on the tire;
one or more rotating sipes formed in each of the tread blocks, each rotating sipe comprising first and second walls that are substantially parallel wherein the first wall includes three points that lie in an imaginary plane and a fourth point that lies outside of the imaginary plane.

2. The vehicle tire of claim 1 wherein the four points are located at respective corners of the rotating sipe.

3. The vehicle tire of claim 1 wherein an angle defined by the imaginary plane, the fourth point, and one of the three points is between 5 and 30 degrees, inclusive.

4. The vehicle tire of claim 1 wherein the tread blocks are polygons.

5. The vehicle tire of claim 1 wherein each rotating sipe further comprises a channel having a width that is greater than a width of the rotating sipe.

6. The vehicle tire of claim 4 wherein the channel is positioned at a periphery of the sipe.

7. The vehicle tire of claim 1 wherein the sipes are arranged in a directional pattern.
